(19) United States
(12) Patent Application Publication
(10) Pub. No.: US 2007/0289685 A1
(43) Pub. Date: Dec. 20, 2007

(54) Body Serving as a Support for a Tire in the Event of Deflation and Tire Assembly Equipped with such a Body

(76) Inventors: Alain Clouet, Saint Maurice (FR); Pascal Auxerre, Royat (FR)

Correspondence Address: Thomas Langer;Cohen, Pontani, Lieberman & Pavane, 551 Fifth Avenue, Suite 1210, New York, NY, 10176, US

(21) Appl. No.: 10/591,928

(22) PCT Filed: Feb. 14, 2005
(86) PCT No.: PCT/EP05/50633

§ 371 Date: Jul. 11, 2007

(30) Foreign Application Priority Data
Mar. 4, 2004 (FR) 0402374

(51) Int. Cl. B60C 17/02

(52) U.S. Cl. 152/520

(57) ABSTRACT

A body (30) designed to be placed inside a tire (10) so as to seal any puncture which a sidewall (12) of said tire may suffer while providing said tire with support. The body (30) comprises a flexible skin (31), of resilient elastomeric material, reinforced by a carcass reinforcement (311) anchored to two inextensible circumferential reinforcement structures (33) incorporated in said skin. The carcass reinforcement (311) is capable of withstanding the forces applied by an inflation pressure corresponding to the rated inflation pressure of the tire inside which the body (30) is placed. An assembly is disclosed formed of a tire (10) mounted on a rim (20) and equipped with such a body (30).

### FIELD OF INVENTION

The invention relates to tires and in particular devices limiting the loss of pressure resulting from puncture of said tires.

### BACKGROUND OF INVENTION

When using a vehicle equipped with rim-mounted tires inflated to their inflation pressure, it may be noted that puncture of a sidewall of a tire causes a very rapid loss of internal inflation pressure, said puncture resulting for example from stress caused by an object external to the tire or from rupture of the very structure of the tire.

Tire/rim assemblies have been developed (see in particular patents U.S. Pat. No. 6,092,575, U.S. Pat. No. 6,418,992, U.S. Pat. No. 5,634,993, U.S. Pat. No. 5,785,781) which, in such a situation, ensure operation comparable to that of the inflated tire, thus allowing the user to continue traveling at least over a minimum distance; in addition, deflation warning devices are provided in the vehicle equipped with such assemblies in order to warn the user of a loss of pressure.

Another alternative consists in modifying the structure of the tires to make it possible for them to bear a load substantially equivalent to their rated load even in the deflated state without significant modification of their performance at least over a minimum utilization distance.

However, not all vehicles, and in particular not all heavy vehicles, are currently equipped with such assemblies or tires. One object of the present invention is to reduce the effects of puncture for tires of conventional type.

To ensure that the effects of puncture on tires of conventional type are delayed for as long as possible, solutions have been proposed in the prior art which consist for example in arranging inside each tire of conventional type another tire of dimensions adapted such that, in the event of puncture of the tire or loss of pressure by the latter, the inner tire might serve as a support for the outer tire. However, the difference in behavior between the initial inflated state of the tire and the state of the tire held up by an inner tire is very considerable (it is no longer the outer tire which is functional but the inner tire) and may be difficult for the driver of the vehicle to adapt to in such a situation.

Devices are also known which are placed in the tire and which, though not inflated in normal use, may reduce pressure loss in the tire in the event of puncture of the latter. The document published under number US2002/0121325 describes such a device. This device comprises a toroidal tube smaller in dimension than the volume of the cavity of the tire, in order as far as possible to prevent interaction between the tire and the tube in normal operation (i.e. inflated tire), this tube being provided with at least one opening for communication between the cavity defined by the tube and the cavity of the tire in which the tube is placed. In the event of puncture of the tire, the inflation pressure in the cavity defined by the tire and the toroidal tube dissipates, whereas said tube comprising only a small opening maintains virtually unchanged pressure at least for long enough for the driver to reach a repair point. The action of the pressure in the tube, of dimensions appropriate to those of the tire inside which it is disposed, causes it to lie against the beads of the tire, which has the effect of holding the beads against the rim flanges and limiting pressure loss in the tube.

However, although it is easy to get the tube to lie against the beads in the case of a tire of an aspect ratio (section height/section width) at least equal to 0.80, this is not the case with a “low ratio” tire, i.e. with a ratio of less than 0.80, since on inflation the tube necessarily adopts an equilibrium shape which is purely pneumatic and tends to distance said tube from the tire.

Finally, said tube does not make it possible to prevent a change in the behavior of the tire, since there is a relatively long gap between the start of loss of pressure from the cavity formed between the tire and the tube and the time at which the tube itself comes into action as a support. Finally, when the tire is supported by the inflated inner tube the geometry of the tire is modified quite substantially relative to that which the same tire adopts when it is inflated and not punctured.

It is an object of the invention to propose a device placed inside a tire which makes it possible at the same time to reduce the loss of inflation pressure from the punctured tire while keeping the tire in its initial inflated shape. Another object is to limit the duration of the interim phase during which the tire passes from the inflated state, in which no device interacts with the tire to a state in which a device according to the invention comes into action.

### SUMMARY OF THE INVENTION

The invention proposes an assembly formed of a rim and a tubeless tire having two beads designed to cooperate with the mounting rim comprising edges or hooks for limiting the axial distance between the beads of the tire, a crown and sidewalls connecting the beads to the crown, this tire defining a cavity with the mounting rim. Inside this cavity there is placed a body toric in form and defining, when the tire is inflated, a cavity inside said body and an outer cavity with the tire, the inner and outer cavities intercommunicating in such a way that the body is not subject to any inflation force in normal use (i.e. tire inflated to its utilization pressure).

This body comprises a skin which may deform easily under the action of inflation pressure, this skin being made of elastomeric material and reinforced by a carcass reinforcement anchored to two inextensible circumferential reinforcement structures, the internal diameter of which is less than the maximum diameter of the rim (corresponding to the diameter of the radially outermost points of the rim hooks), this carcass reinforcement being capable of withstanding the forces applied by an inflation pressure corresponding to the rated inflation pressure of the tire inside which the body is placed, this body being characterized in that, in the event of puncture of the tire, the skin of said body has a flexibility suited to allowing it to deform, at least locally and virtually instantaneously, in order to block at least temporarily said puncture and thus to limit, at least temporarily, the loss of inflation pressure in the outer cavity between the tire and the body, and thus to ensure a “smooth” transition towards a state of equilibrium in which the body is deformed and serves as a support to the tire after complete loss of pressure in the outer cavity.

Flexible skin should be taken to mean a skin having very low or indeed virtually zero structural rigidity, with the exception of the extension rigidity of its reinforcement. Such a skin exhibiting the form of a torus loses its toric shape when it is positioned on a flat surface without supporting element.

To achieve the result sought, it is preferable for the reinforcement structures of the body to be close to the beads of the tire from the initial state (state in which the tire is inflated with the body placed inside) so as to have, through axial separation under the action of the pressure in the inner cavity of the body, a contact action relative to the beads, maintaining the latter in contact with the flanges of the mounting rim. With this contact between parts of the body and the inside of the tire, it is intended that the surface area of the zones in contact between the body and the tire should increase relative to the contact surface which exists when the tire is in the initial state.

Preferably, these supplementary contact surfaces may be intended to ensure an adequate seal between the tire and the body in order to maintain the pressure in this body for as long as possible, while the surfaces in contact with the tire in the initial state comprise means for allowing passage of the inflation atmosphere between the body and the tire. Preferably, the body exhibits only very small contact surfaces with the tire in normal use (i.e. inflated, non-punctured tire) so as to prevent interaction between the tire and the body(frictional contact between the two).

In order to have the desired effect, it is necessary for the body to adopt locally and virtually instantaneously, under the action even of a low internal pressure (i.e. less than or equal to 0.1 bar), a shape suitable for sealing the punctured tire. With this aim in view, the volume of the inner cavity of the body in the inflated tire must be appropriate for the action of low pressure to be effective. In particular, the body may comprise within its cavity a framework which is independent of said body and which is such that said framework imparts a geometry to the body such that the volume of the inner cavity is at least equal to one third of the volume of the maximum cavity of the tire.

A framework independent of said body should be understood to mean either that this framework is not connected to said body or that it is so connected but to an extent which does not prevent modification of the shape of the body inside a tire which abruptly suffers a puncture.

In a variant, the body takes the form of an open torus, in the manner of a tire, the opening being formed substantially between the inextensible circumferential reinforcement structures of said body.

In another variant, the body takes the form of a closed torus and comprises at least one orifice for communication between the inner and outer cavities when said body is in place in a tire and at the same time having the effect of confining the inflation pressure in the inner cavity of the body on puncture of the tire.

In another variant, the framework of the body is formed by at least one toric base spring wound around the rim, the form adopted by this spring imparting a suitable geometry to said body in order to define with the rim an inner cavity volume suited to having the desired effect. This spring may be of spiral type or alternatively formed of a succession of rings which may be resiliently deformed (i.e. resuming its initial form after deformation).

In one variant, the carcass reinforcement of the body comprises at least two plies (or stacks) each formed of a plurality of reinforcement elements, in the form of textile cords or cables, forming, in the radially outermost part of the body, angles of at least 25° with the circumferential direction, the reinforcement elements of the plies being crossed over one another. These reinforcement elements of the carcass reinforcement of the body may be cords or cables of aromatic polyamide.

Furthermore and to ensure better mechanical resistance of the body when the latter serves as a support for the tire, the body may comprise in its crown part, i.e. its part radially to the outside, a reinforcement structure formed of a plurality of reinforcements in the form of continuous or discontinuous cords or cables. Advantageously, the reinforcements of the crown part are arranged in a direction forming an angle of at most 10° with the circumferential direction.

The invention also provides a body having the form of a torus generated by revolution around an axis of rotation and designed to be placed inside a tire so as to seal any puncture said tire may suffer and to reduce the rate at which pressure is lost in the tire while ensuring inflated support for said tire. This body comprises a skin, of resilient elastomeric material capable of deformation, reinforced by a carcass reinforcement anchored to two inextensible circumferential reinforcement structures incorporated in said skin, these inextensible structures having an internal diameter of less than the maximum diameter of the rim, this carcass reinforcement being capable of withstanding the forces applied by an inflation pressure corresponding to the rated inflation pressure of the tire inside which the body is placed.

This body is characterized in that, under the action of local low pressure, i.e. close to 0.1 bar, at least locally said body comes virtually instantaneously into contact with the punctured sidewall of the tire and in that said body is capable of withstanding an inflation pressure equal to the pressure of the tire in which it is intended to be placed.

At least locally should be understood to mean that, viewed in a plane containing the axis of rotation and passing through the tire puncture, the profile of the body is at least in contact with the tire at the site of the puncture.

To achieve such a virtually instantaneous effect, it is necessary to adjust the flexibility of the skin so as to allow it to deform enough at least locally to seal the puncture.

The body according to the invention may have the form of an open or closed torus. In this latter case, it is provided with at least one small opening, said opening being located radially to the inside of the inextensible circumferential reinforcement structures providing anchorage for the carcass reinforcement.

Each inextensible circumferential reinforcement structure of the body according to the invention may be a bead wire of aromatic polyamide, said bead wire making it possible to withstand the forces applied by an inflation pressure equal to the inflation pressure of the tire inside which said body is placed, while facilitating positioning.

Other features and advantages of the invention are revealed by the description made hereafter with reference to the appended drawings, which show embodiments of the subject matter of the invention by way of non-limiting example.

### BRIEF DESCRIPTION OF THE DRAWINGS

FIG. 1 shows an assembly according to the invention comprising a tire mounted on its mounting rim and inflated to its utilization pressure, inside which has been placed a body;

FIG. 2 shows part of the same assembly as that shown in FIG. 1 in which, following puncture of the tire, the body has deformed locally so as to seal the puncture and reduce the rate of deflation of the tire;

FIG. 3 shows the same assembly a few moments after all the pressure in the tire has dissipated (the outer cavity is then at atmospheric pressure);

FIG. 4 shows a framework variant for a body according to the invention used in the assembly of FIGS. 1 to 3;

FIG. 5 shows a variant according to the invention in which the framework of the body comprises an annular toric base spring;

FIG. 6 shows a framework variant making possible a non-inflated body of a form which is not symmetrical.

### DESCRIPTION OF THE PREFERRED EMBODIMENTS

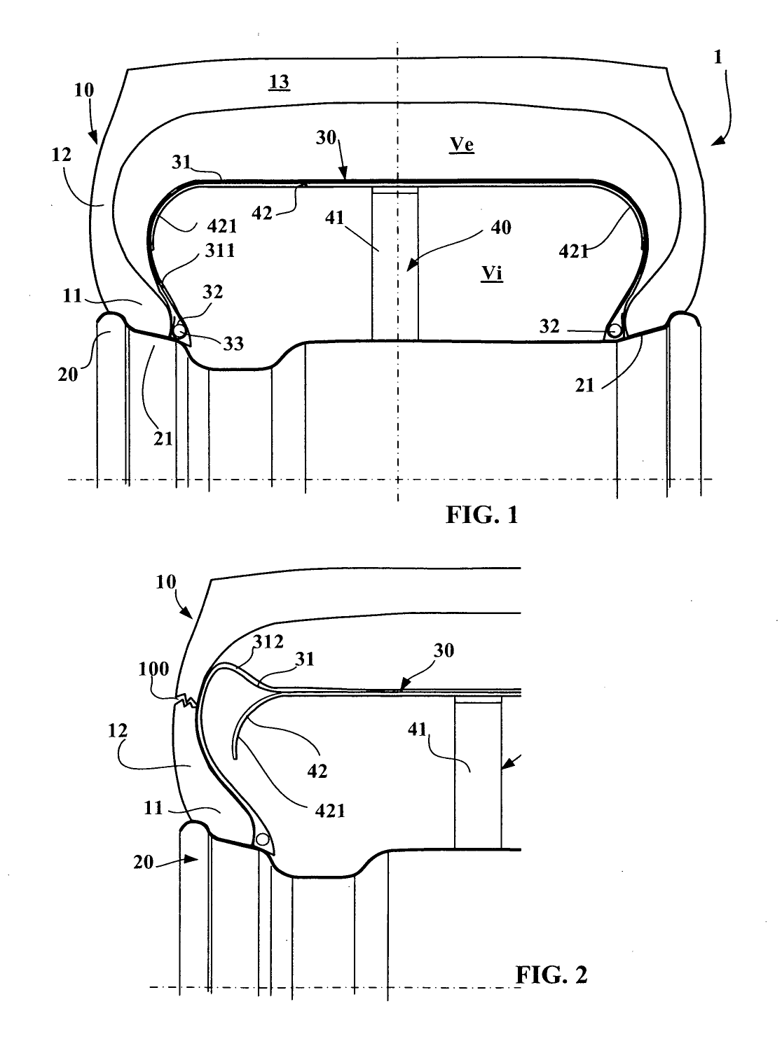

FIG. 1 shows an inflated tire assembly 1 consisting of a tire 10 of dimension 495/45R22.5 (tire of the “drop centre” type) mounted on a mounting rim 20 having seats 21 inclined by an angle of 15°. The tire 10 comprises beads 11 in contact with the seats 21 of the rim 20, and sidewalls 12 connected to a crown 13 whose radially outer part is intended to come into contact with the roadway during travel.

Inside the tire 10 there is mounted a body 30 of toric geometry which, when the tire is inflated, defines on the one hand an outer cavity Ve situated between the tire and said body and on the other hand an inner cavity Vi situated inside said body.

The body 30 is formed of a skin 31 in the form of an open torus terminating at each of its ends in a bead 32. This skin 31 is made of rubber reinforced by a carcass reinforcement 311 anchored in each bead 32 by a tun-up around a circumferential bead reinforcement structure 33.

The carcass reinforcement 311 is formed, in the present case, of two plies each reinforced by a plurality of polyamide reinforcements and crossed from one ply to the other. Before being shaped, the skin 31 is made, for example, on a cylindrical form, not shown, the diameter of which corresponds substantially to that of the circumferential bead reinforcement structures. The plies of the carcass reinforcement are laid on this cylindrical form with the reinforcements of said plies at an angle selected as a function of the final desired angle. Tests have been performed with laying angles of 55°, 58° et 82° (angle measured relative to the circumferential direction).

After laying on this form, the skin is shaped until it assumes a shape such as that illustrated in FIG. 1; the angles of the reinforcements of the carcass reinforcement plies are of course modified during this phase of manufacture of the skin (the angles obtained are respectively 27°, 37° and 78°).

The beads 32 of the body 30 are reinforced by structures 33 comprising an assembly of polyamide reinforcements of a strength suitable for withstanding at least the forces exerted by the carcass reinforcement 311 of the skin when the latter is inflated to a pressure equal to the pressure of the tire intended to be provided with said body.

Furthermore, the body 30 comprises, disposed inside the skin 31, a framework 40 imparting its geometry to said skin 31 when the latter is not inflated. This framework 40 (shown in FIG. 4) comprises a circumferential band 41 which is flexible and circumferentially inextensible and on which a plurality of rigid bows 42 are fixed in such a way that said band 41 is substantially equidistant from the axial ends of the bows 42. In the present case the circumferential band 41 is a metallic band 55 mm wide, 0.8 mm thick and 2.5 m long. This inextensible band 41 is sufficiently flexible to allow it to be flexed to reduce its bulk and thus make possible its introduction into the skin before resuming its initial shape. In the case illustrated in FIG. 4, eight bows 42 are provided, which are fixed firmly to the circumferential band and distributed uniformly over the band 41 in the circumferential direction; each bow 42 is molded to a suitable geometry and is formed of a resin reinforced by reinforcements of aromatic polyamide (it is also possible to use reinforcements of glass fiber or of carbon).

A suitable bow geometry should be understood to mean a transverse geometry (i.e. in the direction of the axis of rotation of the tire/rim assembly) which is appropriate for imparting to the skin a mean meridian section geometry so as to be able to define the inner and outer cavities. In particular, each bow 42 comprises a rounded part 421 at each of its axial ends to avoid damaging the skin 31 with said ends.

The overall length of the bows 42 is 396 mm.

In the configuration illustrated in FIG. 1, the tire 10 is inflated by means of a single valve (not shown); means (for example, striae on the beads of the body) are provided so that the same inflation pressure is established both in the inner cavity Vi and in the outer cavity Ve.

In the present case, the circumferential length of the band 41 of the framework 40 is selected such that the body does not come into contact with the tire when the latter is inflated and bearing its rated load, with the exception of the beads 32 of the body 30, which are in contact with the beads 11 of the tire 10.

Preferably, the circumferential length of the band 41 is determined such that the volume of the inner cavity Vi is at least equal to half the volume of the outer cavity Ve. Still more preferably, the volume of the inner cavity Vi is at least equal to the volume of the outer cavity Ve.

In this configuration, it is essential for the body 40 not to be subject to the inflation pressure, so that it may act effectively as will now be described with reference to FIG. 2.

FIG. 2 shows a partial section of the tire 10 at a point where the sidewall 12 has suffered a puncture 100 following stress external to the tire. Virtually instantaneously, the inflation fluid present in the outer cavity Ve begins to escape through the puncture 100, the pressure in the outer cavity Ve tending to diminish locally (at least in a first phase). This local variation in inflation pressure in the outer cavity Ve creates an imbalance between the pressures in the outer cavity Ve and the inner cavity Vi. It follows that the skin 31 is then instantaneously and locally subjected to this difference in pressure; given its great flexibility, it deforms locally until it seals the puncture 100.

Thanks to this first mechanism, it is possible to reduce the rate of leakage of the inflation fluid in the outer cavity Ve.

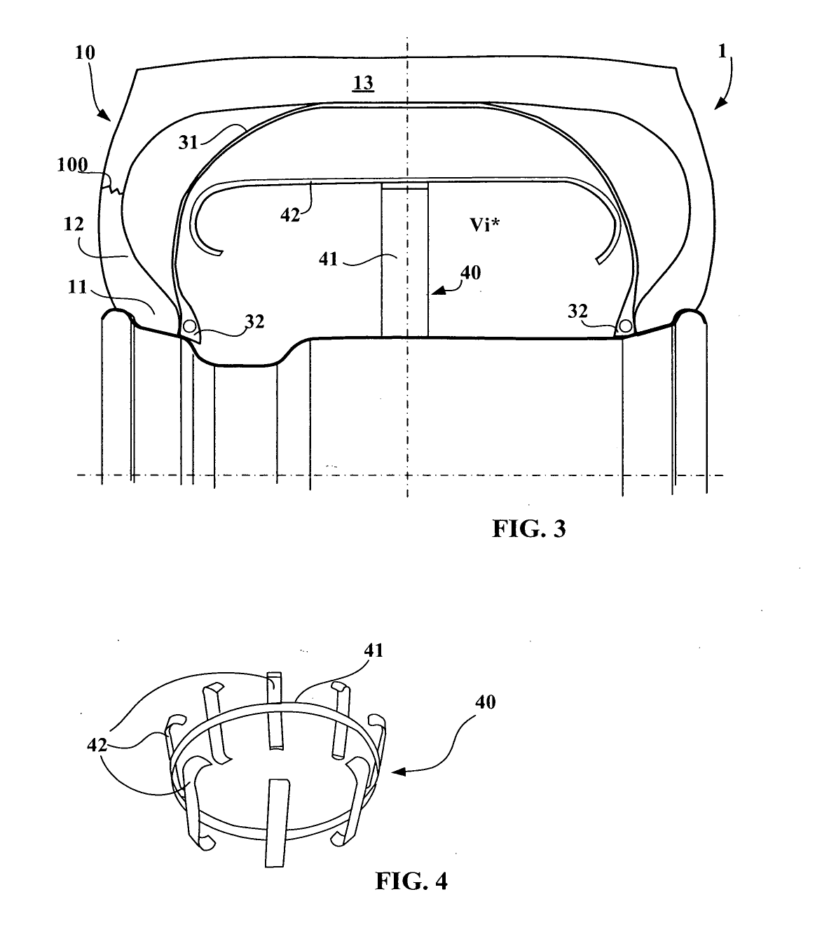

In the moments which follow this intermediate state, and although the leakage rate of the inflation fluid has been reduced, the drop in pressure in the outer cavity Ve will nonetheless affect the whole of said cavity. During this drop in pressure, the entire skin 31 gradually inflates, finally adopting a geometry as shown in FIG. 3, with the beads 32 of the body resting against the beads of the tire.

The difference in pressure between outer cavity Ve and inner cavity Vi also causes the beads 32 of the body 30 to lie more firmly against the beads 11 of the tire 10, so ensuring that the beads 11 of the tire are held on the rim. The means which allowed inflation of the tire may advantageously be designed to close up at the time of this contact under elevated pressure, so as to limit the loss of pressure by leakage between the body 30 and the tire. It should be noted that, even if a leak exists, it remains slight and the body 30 according to the invention makes it possible to prevent an abrupt and instantaneous loss of tire performance.

FIG. 3 shows the punctured tire 10 after the outer cavity Ve has reached a pressure value equal to atmospheric pressure. In this state, the skin 31 (not integral with the framework 40) is so deformed as to occupy a large part of the inside of the tire 10. The pressure in the inner cavity Vi is again sufficient to keep the tire in a configuration reasonably close to how it was before the puncture. This is sufficient to prevent abrupt deflation and instantaneous loss of tire running performance. In this FIG. 3, it may be seen that the bows 42 may be flexed by the skin 31, which justifies the presence of rounded parts 421 designed to prevent the ends of said bows from injuring the skin.

As FIGS. 2 and 3 also show, the structure of the skin is suitably reinforced in order to be in a position to withstand the forces imposed both in the intermediate puncture-sealing phase (very short phase following puncture) and in the final phase of inflation of the skin inside the tire.

As a variant embodiment of the carcass reinforcement plies, it is possible to use, instead of polyamide reinforcements, textile reinforcements or alternatively small-diameter metal cords (i.e. of a diameter of at most 0.2 mm). It is also possible to use discontinuous fibers of a diameter of at most 0.2 mm.

To ensure good resistance of the body inside the inflated, non-punctured tire when the tire and the body are subjected to centrifugation forces, it is advantageous to reinforce the radially outermost part of the skin with a crown reinforcement comprising a plurality of reinforcements of appropriate rigidity. For example, this reinforcement may be formed of circumferentially oriented textile cords or cables (i.e. forming an angle of less than or equal to 10° with the circumferential direction). Discontinuous reinforcements may also be used, whether for the crown reinforcement or for the carcass reinforcement. Undulating reinforcements may also be used to reinforce the crown reinforcement.

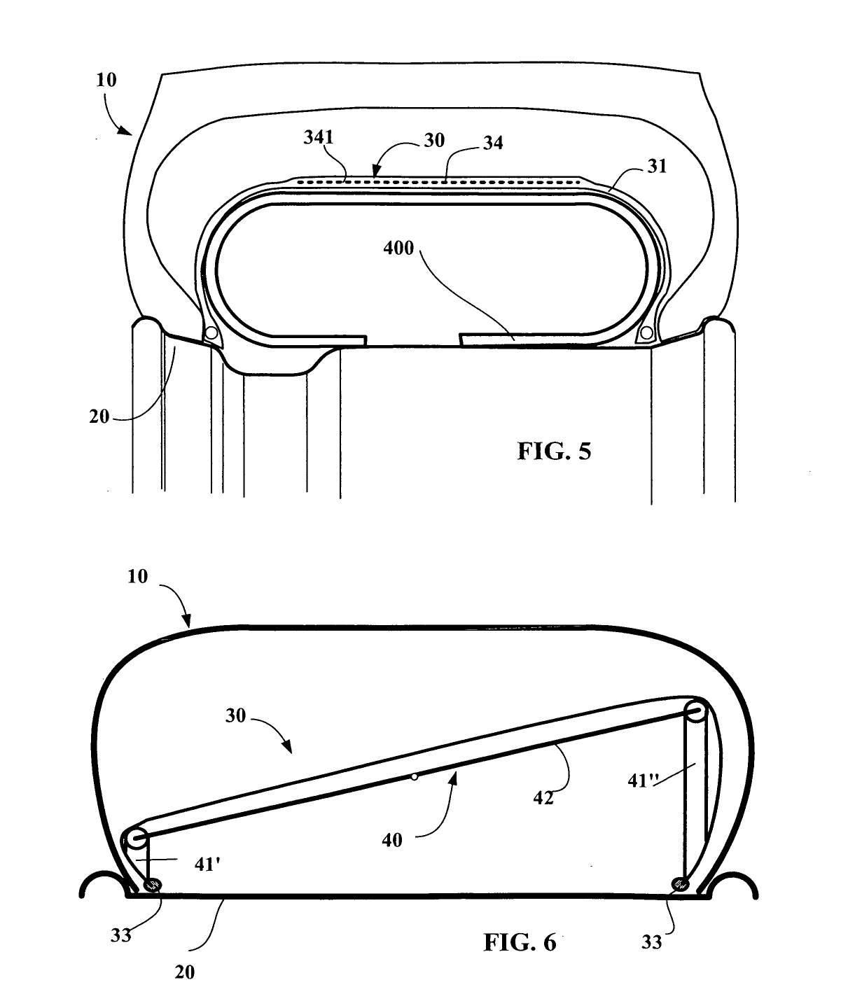

FIG. 5 shows a framework variant 400 for a body 30 according to the invention, this framework being formed of a toric base annular spring 401 placed inside the skin 31 of the body so as to impart to said body a geometry such that said body 30 defines an inner cavity volume with the rim 20 and an outer cavity volume with the tire 10, said cavities communicating with one another. The spring 401 used in this variant has the advantage of being able to be put in place in the skin 31 by making use of its deformation resilience, so facilitating mounting of the body in the tire. This same deformation resilience allows the spring to resume its initial geometry and thus to impart to the body the desired geometry once in place in the tire. Moreover, in this variant, the body comprises a crown part 34 reinforced by a reinforcement structure 341 formed of a plurality of reinforcements in the form of continuous or discontinuous cords or cables. Preferably, the mean angle said reinforcements of the reinforcement structure of the crown part 34 form with the circumferential direction is at most 10°.

FIG. 6 is a schematic representation of a framework variant allowing utilization of a non-inflated body whose geometry in a meridian plane is not symmetrical relative to a median plane (plane perpendicular to the axis of rotation and extending equidistantly from the beads of the body when the latter is in place in the tire). For the purpose of simplification, the same reference numerals are used here to designate elements comparable to those of the variant shown in FIGS. 1 to 4.

The framework 40 is here formed of a plurality of flexible bows 42 disposed transversely and fixed at their axial ends to two circumferentially inextensible bead wires 41′, 41″, said bead wires 41′, 41″ having different circumferential lengths from one another. Introduction of this framework 40 into a skin 31 of a body 30 of appropriate profile results in the obtainment of a meridian profile which is asymmetrical relative to a plane perpendicular to the axis of rotation. Thus, it is possible to bring the profile of the skin 31 closer to at least one sidewall of the tire.

A flexible bow should here be understood to mean that a bow may flex under a slight force so as to make it possible to bring the circumferentially inextensible bead wires axially closer together once the tire, inside which is placed the body, has been punctured.

In this manner, it may be possible to increase still further the effectiveness of the body according to the invention by reducing sealing time with the closer sidewall; this arrangement may be useful where it is known that it is the sidewall oriented towards the outside of a vehicle which is most subject to stresses and thus to puncture.

The subject matter of the invention may be used in the case of tires of conventional type, be it for passenger vehicles, heavy vehicles, off road vehicles or aircraft. It goes without saying that tires designed to function even in the event of total or partial deflation (in particular tires incorporating means allowing flat running or indeed the mounted assemblies recalled in the introduction) may be additionally provided with a body according to the invention with the aim of reducing the rate at which inflation pressure is lost in the event of a puncture.

1. An assembly (1) comprising:
a tubeless tire (10) mounted on a mounting rim (20), this tire having two beads (11) designed to cooperate with the mounting rim (20) comprising edges for limiting the axial distance between the beads of the tire, this tire having furthermore a crown (13) and sidewalls (12) connecting the beads (11) to the crown, this tire defining with the mounting rim (20) a cavity; and
a body (30) toric in form placed in said cavity and defining, when the tire is inflated, a cavity inside said body (30) and an outer cavity with the tire, the inner and outer cavities intercommunicating in such a way that the body (30) is not subject to any inflation force in normal use (i.e. tire inflated to its utilization pressure), this body (30) comprising a skin (31), of resilient elastomeric material capable of deformation, reinforced by a carcass reinforcement (311) anchored to two inextensible circumferential reinforcement structures (33), whose internal diameter is less than the maximum diameter of the rim (20), this carcass reinforcement (311) being capable of withstanding the forces applied by an inflation pressure corresponding to the rated inflation pressure of the tire inside which the body (30) is placed,
wherein in the presence of a puncture (100) in the tire, the skin (31) deforms, at least locally and virtually instantaneously, in order to block at least temporarily the puncture (100) so as to limit, at least temporarily, the loss of inflation pressure in the outer cavity between the tire and the body, and to ensure transition to a state of equilibrium in which the body (30) is deformed and serves as a support for the tire (10) after complete loss of pressure in the outer cavity.

2. The assembly (1) according to claim 1, wherein the body (30) is a closed torus provided with at least one opening for communication between the inner and outer cavities.

3. The assembly (1) according to claim 1, wherein the body (30) is a torus which is open substantially axially between the inextensible circumferential reinforcement structures (33) of said body.

4. The assembly (1) according to claim 1, wherein the carcass reinforcement (311) of the body (30) comprises at least two plies each formed of a plurality of reinforcement elements, in the form of textile cords or cables, forming, in the radially outermost part of the body, angles of at least 25° with the circumferential direction, the reinforcement elements of the plies being crossed over one another.

5. The assembly (1) according to claim 4, wherein the reinforcements of the carcass reinforcement (311) of the body (30) are cords or cables of aromatic polyamide.

6. The assembly (1) according to claim 1, wherein the body (30) comprises a crown part (34) radially towards the outside, said crown part comprising a reinforcement structure (341) formed of a plurality of reinforcements in the form of continuous or discontinuous cords or cables.

7. The assembly (1) according to claim 6, wherein the reinforcement structure of the crown part (34) of the body (30) comprises a plurality of reinforcements disposed in a direction forming an angle of at most 10° with the circumferential direction.

8. The assembly (1) according to claim 1, wherein the body (30) comprises a framework (40, 400) placed inside said body and independent of said body, said framework having the function of causing the body (30) to adopt a form defining an inner cavity volume at least equal to one third of the maximum cavity volume defined by the tire (10) and its mounting rim (20).

9. The assembly (1) according to claim 8, wherein the framework (40) comprises at least one circumferential band (41) of a rigidity appropriate for imparting to the body (30) a circumferential length appropriate to said body and, firmly connected to said band (41), a plurality of bows (42) imparting their shape to the body (30) in the transverse direction.

10. A body (30) of toric geometry around an axis of rotation and designed to be placed inside an assembly formed of a tire (10) mounted on a mounting rim (20) so as to seal any puncture (100) which said tire (10) may suffer and to reduce the rate at which pressure is lost in the tire while providing said tire with an inflated support, this body (30) comprising:
a skin (31), of resilient elastomeric material, reinforced by a carcass reinforcement (311) anchored to two inextensible circumferential reinforcement structures (33) incorporated in said skin (31);
wherein the inextensible structures (33) have an internal diameter of less than the maximum diameter of the rim (20);
wherein the carcass reinforcement (311) is capable of withstanding the forces applied by an inflation pressure corresponding to the rated inflation pressure of the tire inside which the body (30) is placed;
wherein the body is such that, under the action of local pressure less or equal to 0.1 bar, said body (30) comes virtually instantaneously into contact with the tire (10) at the site of the puncture (100), and said body (30) is capable of withstanding an inflation pressure equal to that of the tire (10) in which it is intended to be placed, said body (30) being a closed torus whose skin (31) is provided with at least one small opening, said opening being located radially to the inside of the inextensible circumferential reinforcement structures (33) providing anchorage for the carcass reinforcement (311).

11. (canceled)

12. The body (30) of toric geometry according to claim 10, wherein the body (30) is a torus open axially between the inextensible circumferential reinforcement structures (33) providing anchorage for the carcass reinforcement (311).

13. The body (30) of toric geometry according to claim 10, wherein the carcass reinforcement (311) of the body (30) comprises at least two plies each formed of a plurality of reinforcement elements, in the form of textile cords or cables, oriented on the inflated body in directions forming angles of at least 25° with the circumferential direction, the reinforcement elements of the stacks being crossed over one another.

14. The body (30) of toric geometry according to claim 13, wherein the reinforcements of the carcass reinforcement (311) of the body are cords or cables of aromatic polyamide.

15. The body (30) of toric geometry according to claim 10, wherein the body (30) comprises a crown part (34) radially towards the outside, said crown part comprising a reinforcement structure (341) formed of a plurality of reinforcements in the form of continuous or discontinuous cords or cables.

16. The body (30) of toric geometry according to claim 15, wherein the reinforcement structure of the crown part (34) of the body (30) comprises a plurality of reinforcements disposed in a direction forming an angle of at most 10° with the circumferential direction.

17. The body (30) of toric geometry according to claim 10, wherein each inextensible circumferential reinforcement structure (33) is a bead wire of aromatic polyamide, said bead wire making it possible to withstand the forces applied by an inflation pressure equal to the inflation pressure of the tire inside which said body is placed, while facilitating positioning.

18. The body (30) of toric geometry according to claim 10, comprising means of imparting a geometric shape to said body (30) including a framework (40, 400), of appropriate rigidity, placed inside the skin (31) while being independent of said skin (31), this geometric shape defining a cavity volume at least equal to one third of the internal volume of the tire (10) in which the body (30) is intended to be placed.

19. The body (30) of toric geometry according to claim 18, wherein the framework (40, 400) comprises at least one circumferential structure (41, 41′, 41″) of suitable rigidity for imparting to the skin (31) a given circumferential dimension and, firmly connected to said circumferential structure (41, 41′, 41″), a plurality of transverse bows (42) imparting their shape to the body (30) in the transverse direction.

20. A body (30) of toric geometry according to claim 18, wherein the framework (40) comprises two circumferential structures (41′, 41″) of suitable rigidity for imparting to the skin (31) a given circumferential dimension at two axially distinct points, these two circumferential structures (41′, 41″) being connected by at least one bow (42) whose function is to hold said two structures axially apart.

21. The body (30) of toric geometry according to claim 18, wherein the framework (400) comprises at least one toric base annular spring (401) imparting its toric shape to the skin (31).
